(19) United States
(12) Patent Application Publication
(10) Pub. No.: US 2010/0013854 A1
(43) Pub. Date: Jan. 21, 2010

(54) GPU BEZIER PATH RASTERIZATION

(75) Inventor: Ashraf Michail, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/175,454

(22) Filed: Jul. 18, 2008

(51) Int. Cl. G09G 5/00

(52) U.S. Cl. 345/615; 345/611

(57) ABSTRACT

Hybrid architecture of supersampling and computing distance from a feature edge or Bezier evaluation to address thin feature support in graphics systems. To avoid missing some features the technique creates a supersampling of a small number of supersamples to pick up the thin features. By supersampling, samples can be produced on both sides of a thin feature, which causes thin features to be detectable by some pixel. Now that the thin features hit some pixel, the quality is achieved by a distance-from-edge approach. For example, the technique can supersample four times in combination with the distance-from-edge approach, produce another four samples there resulting in a 16-sample result.

### BACKGROUND

Moving more graphics computation onto the graphics processing unit (GPU) improves upon what typically has been processed on the device central processing unit (CPU) due to the parallelism, better memory bandwidth, and specialized hardware for graphics operations provided on GPUs. However, the GPU is only capable of rasterizing triangles with geometry shaders, vertex shaders, and pixel shaders. Drawing a path (where paths are combinations of Bézier curves patched together, not bound by the limits of rasterized images, and are intuitive to modify) requires some translation into a form the GPU can understand. Traditional approaches perform this translation step on the CPU and oftentimes become CPU bound.

A traditional approach to anti-aliasing is supersampling where the technique includes conceptually drawing at a higher resolution and then downsampling with a filter pattern to produce anti-aliasing results. A shortcoming of supersampling is that it generally scales in performance with the number of samples and for high user interface (UI) quality sixteen samples or more should be used. This can result in approximately sixteen times in speed reduction and sixteen times the memory requirement, based on the implementation. A multi-pass approach can be employed, which is slower, but uses less memory.

Another approach to anti-aliasing is that which is supported by the hardware natively and which includes multi-sample buffers that run the pixel shader once per pixel. This approach produces the coverage information for the geometry at a higher resolution and generates the anti-aliasing information for the triangle data. However, the multi-sample approach has shortcomings. The quality varies significantly with the specific parts. Most hardware has some minimum number of samples (e.g., four samples) which is insufficient for high quality vector graphics. Moreover, multi-sample anti-aliasing is different from different GPU vendors providing an inconsistent look. Additionally, multi-sample anti-aliasing can run the pixel shader only once per pixel. Thus, using Bezier flattening techniques in a pixel shader results in an aliased output because pixel shader evaluation of curves is suboptimum.

A third approach to anti-aliasing that is commonly used involves techniques based on the distance from a sample point to an edge. In the pixel shader, the distance from the edge of the geometry can be computed and the alpha falloff produced to obtain an anti-aliased result. Using this approach, draw can be completely aliased without the cost of supersampling and without the additional costs associated with multi-sample buffer. Anti-alias edges along the Bezier can be obtained; however, because the pixel shader is only run once per pixel and because the pixel shader will only run on the pixel if the pixel is contained within the geometry, if the geometry is thin then this approach is incapable of rendering the thin geometry.

Consider a 1-pixel line at an angle (e.g., an arc around the direct angle), which is common in the UI. It is possible to miss all of the sample points for that thin feature. When drawing aliased, there is a sample point in the center of each pixel, and if the geometry does not intersect the sample point, nothing is drawn. Thus, for a 1-pixel wide line at an angle, the geometry disappears. Thus, a shortcoming of this third approach is if the feature gets thin, the feature can simply disappear.

Another shortcoming is that corners are inaccurate because corners can miss sample points as well. An approach to address this is to use a combination of a pixel shader and the multi-sample buffer. The multi-sample buffer helps with corners because the corners often have associated geometry that also matches the corners and in some way produces a masking effect on the edge for the multi-sample buffer. However, this approach still does not solve the thin feature problem in cases where there is no edge geometry, for example, when Bezier flattening is done in the pixel shader near a thin feature. Basically the one pixel wide curves disappear, and corners, although better, are not accurate with multi-sample buffer.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture at least solves a problem of drawing a basic curve using a graphics processing unit (GPU) and, obtaining high quality anti-aliasing in the output. Generally, supersampling is employed to produce pixel shader samples at higher frequency to allow the pixel shader to run on all the relevant pixels for thin shape support. A vertex shader computes anti-aliasing sampling information. A triangulation algorithm is employed that can supersample only along the edges rather than the entire shape.

The technique is a hybrid of supersampling and an approach for computing distance from a feature edge with Bezier evaluation. To avoid missing some features the technique creates some supersampling of a small number of supersamples (e.g., three or four samples) which can slow processes accordingly based on the number of supersamples. For example, when using four supersamples, processes can be slowed down by a factor of four and that by itself is insufficient quality for rendering in the user interface (UI). However, this is sufficient quality to pick up the thin features. In other words, by supersampling a little, samples can be produced on both sides of a thin stroked edge, which causes thin features to be detectable by some pixel. Now that the thin features hit some pixel, the quality is going to be achieved by a distance-from-edge approach. For example, the technique can supersample four times in combination with the distance-from-edge approach, producing another four samples resulting in a 16-sample result.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented graphics processing system in accordance with the disclosed architecture.

FIG. 2 illustrates a more detailed graphics processing system in accordance with the disclosed architecture.

FIG. 3 illustrates a flow block diagram for GPU path rasterization.

FIG. 4 illustrates a computer-implemented method of processing graphics.

FIG. 5 illustrates a method of path rasterization.

FIG. 6 illustrates a method of sampling an edge.

FIG. 7 illustrates a block diagram of a computing system operable to employ a GPU that generates Bezier path rasterization in accordance with the disclosed architecture.

### DETAILED DESCRIPTION

The disclosed architecture at least solves the problem of drawing a basic curve using the graphics processing unit (GPU) and obtaining high quality anti-aliasing in the output. Supersampling is employed to produce pixel shader samples on both sides of a thin feature to allow shader processing on all the relevant pixels for thin shapes (e.g., 1-pixel wide lines). A vertex shader computes anti-aliasing sampling information, rather than using ddx/ddy to approximate the distance from an edge. A ddx instruction computes approximate partial derivatives with respect to the X window coordinate to yield a result vector. The partial derivatives are evaluated at the center of the pixel. Similarly, the ddy instruction computes approximate partial derivatives with respect to the Y window coordinate to yield a result vector. The partial derivatives are also evaluated at the center of the pixel. A triangulation algorithm is employed that can supersample only along the edges rather than sampling the entire shape.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

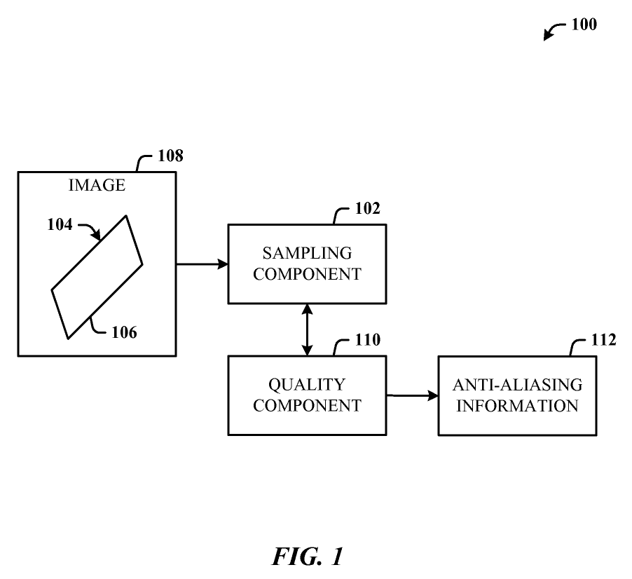

FIG. 1 illustrates a computer-implemented graphics processing system 100 in accordance with the disclosed architecture. The system 100 includes a sampling component 102 for sampling an edge 104 of an object 106 in an image 108 (a scene) to resolve geometry information. The system 100 can also include a quality component 110 for increasing quality of the image 108 by computing anti-aliasing sampling information 112. The sampling component 102 supersamples the edge 104 to produce samples for a shader. The shader can be a pixel shader that samples at a higher frequency (to run on both sides of the edge 104) to run on pixels relevant to the edge 104.

The system 100 and other embodiments described herein employ supersampling and an approach for computing distance from a feature edge or Bezier evaluation. To avoid missing some features the technique creates some supersampling of a small number of supersamples (e.g., three or four samples) which can slow processes accordingly based on the number of supersamples. For example, when using four supersamples, processes can be slowed down by a factor of four and that by itself is insufficient quality for rendering in the user interface (UI). However, this is sufficient quality to pick up the thin features. In other words, by supersampling a little, samples can be produced on both sides of a feature edge, which causes thin features to be detectable by some pixel. Now that the thin features hit some pixel, the quality is going to be achieved by a distance-from-edge approach. For example, the technique can supersample four times in combination with the distance-from-edge approach, produce another four samples there resulting in a 16-sample result which looks good by using the pixel shader to increase quality.

The system 100 can be employed entirely in the GPU by using supersampling in the GPU and one or more shaders to produce additional samples. It is to be understood that an alternative implementation employs FPGA (field programmable gate array) technology where the software is employed in a hardware solution. Generally, one approach provides the ability to vary the number of times the pixel shader runs per pixel (which can be assisted by the utilization of multi-sample buffers).

More specifically, in order to provide more widespread use, rather than computing distance in the pixel shader, the disclosed approach replicates the Bezier information in a vertex shader and takes multiple samples based on the Bezier information, where “replication” includes replication and adjustment of the positions to the different sample points in the vertex shader, and then the pixel shader evaluates the Bezier off multiple coordinates. The distance function is removed from the pixel shader; the Bezier information is replicated at different positions in the vertex shader, and evaluated more easily in the pixel shader. Anti-aliasing computation is moved from per pixel to per vertex.

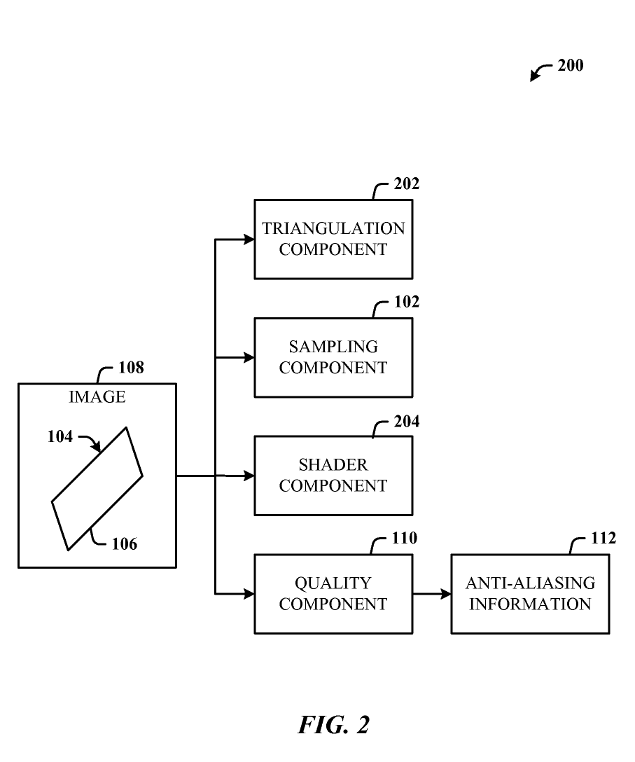

FIG. 2 illustrates a more detailed graphics processing system 200 in accordance with the disclosed architecture. The system 200 includes the sampling component 102 for sampling the edge 104 of the object 106 in the image 108 (a scene) to resolve the geometry information. The system 200 also includes the quality component 110 for increasing the quality of the image 108 by computing the anti-aliasing sampling information 112.

The system 200 can further comprise a triangulation component 202 for generating triangle data as texture data supersampling on sides of the edge 104 and converting supersamples into texture data. A shader component 204 can include one or more shaders that facilitate final path rasterization of a Bezier path. For example, the shader component 204 can include a vertex shader for computing offset texture units based on a supersampled aspect of a thin feature, a pixel shader for performing additional sampling using the offset texture units, and a downsampling shader for downsampling the scene to produce a final scene result.

The aspect can be an edge of the thin feature, which edge is 1-pixel wide. The pixel shader runs at a higher frequency to capture thin geometry features. The offset texture units that are computed by the vertex shader are utilized as anti-aliasing sampling information. The triangulation component 202 can generate triangle data as the offset texture units based on triangulation along a Bezier curve as applied to the thin feature. The vertex shader, pixel shader and downsampling shader operate exclusively on a GPU to provide Bezier path rasterization.

Alternatively, the sampling component 102 can include a pixel shader for supersampling the edge of the thin feature.

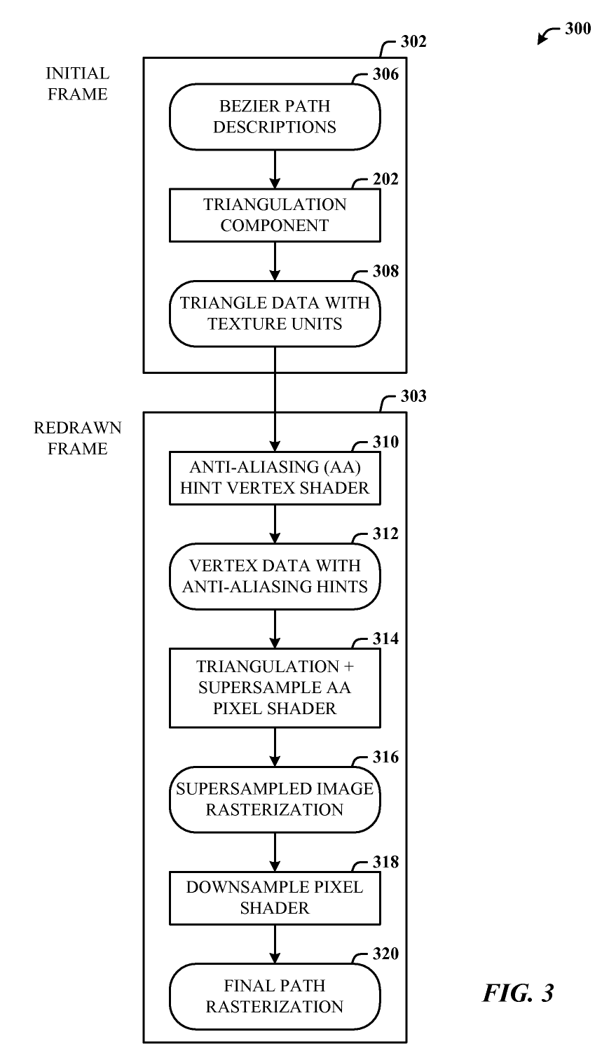

FIG. 3 illustrates a flow block diagram 300 for GPU path rasterization. The process can begin with two frame systems: an initial frame system 302 and then a redrawn frame system 304 for final rendering. The processing associated with the initial frame system 302 can be performed by the CPU, and the redrawn frame system 304 can be performed by the GPU.

The triangulation approach utilizes the triangulation component 202 to receive Bezier path descriptions 306 (also referred to as Bezier information) and produces triangulation with the associated Bezier coordinates. The Bezier coordinates are evaluated per pixel. Once produced, the triangulation is now reusable (as vertex data) and can be drawn several times at different scale factors, transforms, and so on. The initial frame system 302 takes the preprocessing work, which can also be performed at authoring time. The output of the triangulation component 202 is the triangle data 308 (e.g., coordinates) as or with texture units (or data). A tool can be utilized to generate the triangulation data and a runtime load post-processed work. The preprocessing work produces the triangle data, which can be performed on the computing system (or CPU).

The redrawn frame system 304 is the work that is done on the GPU and is performed per frame. The work on the redrawn frame system 304 can be animated with scale transforms, and so on. The triangle data 308 includes texture units that runs a vertex shader 310 (with anti-aliasing hints) which replicates the triangle coordinates based on the transform, or more specifically, replicates the Bezier terms based on the transforms (as the vertex data with anti-aliasing hints 312) and passes the terms into a pixel shader 314 (which can also perform additional sampling). The pixel shader 314 then generates a supersampled buffer for the scene rasterization at 316. A downsample shader 318 takes the supersampled buffer contents and then downsamples to the final path (or target) resolution, at 320. So generally, the process redraws the thin feature larger and then re-samples down with a pixel shader to produce the final rasterization.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

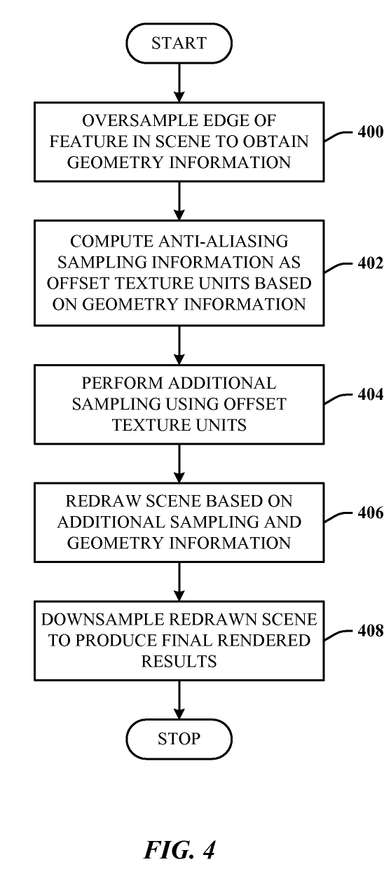

FIG. 4 illustrates a computer-implemented method of processing graphics. At 400, an edge of a feature in an image is oversampled to obtain geometry information. At 402, anti-aliasing sampling information is computed as offset texture units based on the geometry information. At 404, additional sampling is performed using the offset texture units. At 406, the scene is redrawn based on the additional sampling and geometry information. At 408, the redrawn scene is downsampled to produce final rendered results.

The offset texture units can be offset Bezier texture units obtained from a Bezier object. The method can further comprise running a pixel shader at a higher frequency to obtain samples of a thin feature such as a 1-pixel wide feature. The method can further comprise running a vertex shader to compute the anti-aliasing sampling information, and running a pixel shader to obtain the additional sampling.

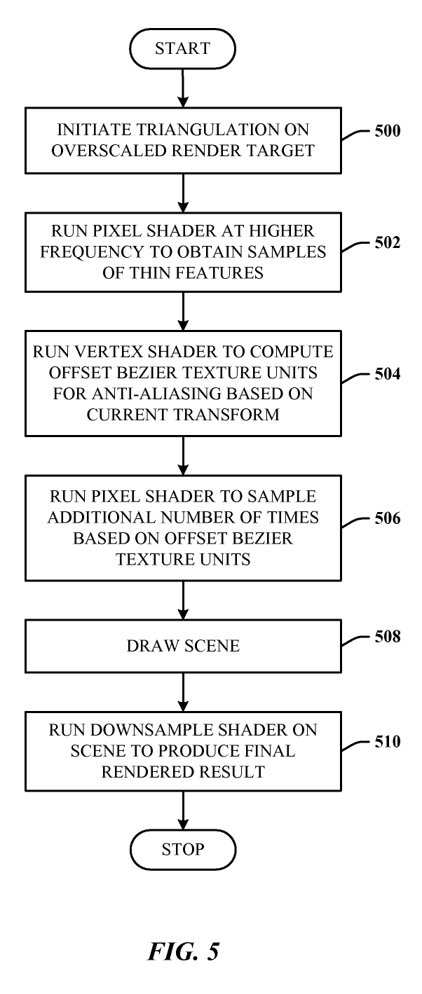

FIG. 5 illustrates a method of path rasterization. At 500, triangulation is initiated on overscaled render target. For example, with respect to overscaling, both the horizontal and vertical resolutions can be doubled. At 502, a pixel shader is run on both sides of an edge to obtain samples. Running at higher frequency picks up samples normally missed by one pixel wide lines. At 504, a vertex shader is run to compute offset Bezier texture units for anti-aliasing based on current transform(s). At 506, a pixel shader is run to sample an additional number of times in the pixel shader based on the offset Bezier texture units. For example, with 2×2 (horizontal by vertical) overscaling, at 500, and four samples, at 504, there are 2×2×4=16 samples per pixel for high quality anti-aliasing. Other overscaling and samples can be employed, as desired. At 508, the scene is drawn. At 510, after the scene has been drawn, a downsample shader is run on the scene to produce the final rendered result.

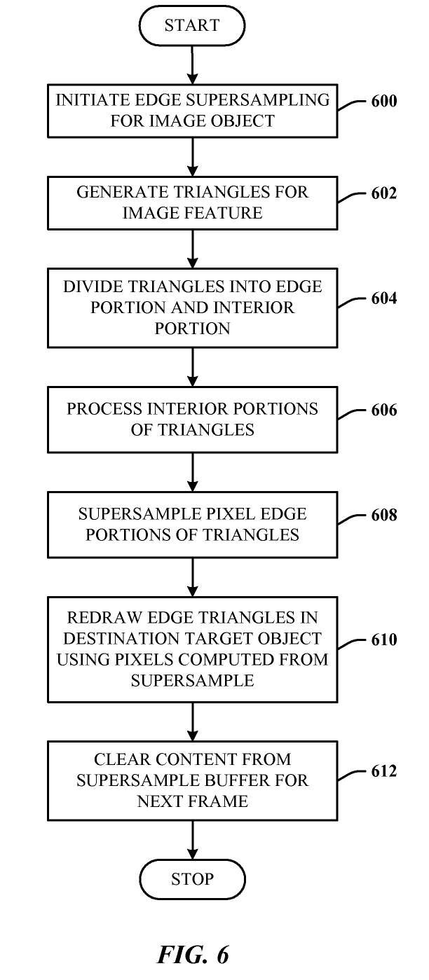

FIG. 6 illustrates a method of sampling an edge. At 600, edge supersampling is initiated. At 602, triangles are generated for an image feature. At 604, each triangle is divided into an edge portion and an interior portion. At 606, the interior portions of the triangles are processed. This can be performed in an aliased mode. At 608, the pixel edge portions of the triangles are supersampled. For example, the supersampling can be run into a supersampled buffer. At 610, the edge triangles are redrawn in the destination target object using pixels computed from the supersample. The redraw can be performed using only those pixels computed in the supersample buffer for pixels along the edge. At 612, the content of the supersample buffer is cleared for the next frame. This can be accomplished by redrawing the edge triangles into the supersampled buffer to clear the content, to the background color, for example, to avoid a full surface clear.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

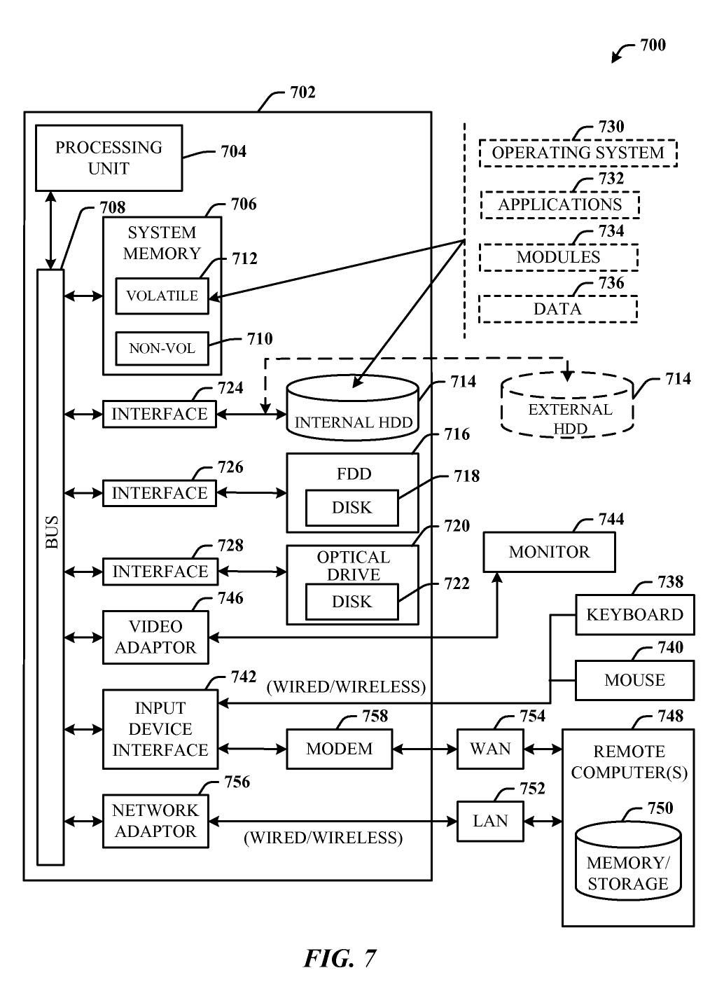

Referring now to FIG. 7, there is illustrated a block diagram of a computing system 700 operable to employ a GPU that generates Bezier path rasterization in accordance with the disclosed architecture. In order to provide additional context for various aspects thereof, FIG. 7 and the following discussion are intended to provide a brief, general description of a suitable computing system 700 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 7, the exemplary computing system 700 for implementing various aspects includes a computer 702 having a processing unit 704, a system memory 706 and a system bus 708. The system bus 708 provides an interface for system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 can include non-volatile memory (NON-VOL) 710 and/or volatile memory 712 (e.g., random access memory (RAM)). A basic input/output system (BIOS) can be stored in the non-volatile memory 710 (e.g., ROM, EPROM, EEPROM, etc.), which BIOS are the basic routines that help to transfer information between elements within the computer 702, such as during start-up. The volatile memory 712 can also include a high-speed RAM such as static RAM for caching data.

The computer 702 further includes an internal hard disk drive (HDD) 714 (e.g., EIDE, SATA), which internal HDD 714 may also be configured for external use in a suitable chassis, a magnetic floppy disk drive (FDD) 716, (e.g., to read from or write to a removable diskette 718) and an optical disk drive 720, (e.g., reading a CD-ROM disk 722 or, to read from or write to other high capacity optical media such as a DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 712, including an operating system 730, one or more application programs 732, other program modules 734, and program data 736. All or portions of the operating system, applications, modules, and/or data can also be cached in the volatile memory 712. It is to be appreciated that the disclosed architecture can be implemented with various commercially available operating systems or combinations of operating systems.

A user can enter commands and information into the computer 702 through one or more wire/wireless input devices, for example, a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, etc.

A monitor 744 or other type of display device is also connected to the system bus 708 via an interface, such as a video adaptor 746. The adaptor 746 is operable to include the sampling component 102, quality component 110, anti-aliasing information 112, shader component 204, vertex shader 310, pixel shader 314, downsample shader 318, and associated data (e.g., vertex data with aliasing hints 312, image rasterization 316, and final path rasterization), for example. The triangulation component 202 can be operable on the computing 702.

In addition to the monitor 744, a computer typically includes other peripheral output devices (not shown), such as speakers, printers, etc.

The computer 702 may operate in a networked environment using logical connections via wire and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, is connected to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented graphics processing system, comprising:
a sampling component for sampling an edge in an image to resolve geometry information; and
a quality component for increasing quality of the image by computing anti-aliasing sampling information.

2. The system of claim 1, wherein the sampling component supersamples the edge to produce samples for a shader.

3. The system of claim 2, wherein the shader is a pixel shader that samples at a higher frequency to run on pixels relevant to the edge.

4. The system of claim 1, further comprising a triangulation component for supersampling on sides of the edge and converting supersamples into texture data.

5. The system of claim 1, further comprising a shader component for computing the anti-aliasing sampling information.

6. The system of claim 1, further comprising a downsampling component for downsampling the image to output a final rasterization path, the image includes the edge.

7. The system of claim 1, wherein the sampling component and the quality component are employed on a graphics processing unit (GPU) such that thin features are rendered in the image entirely via the GPU.

8. A computer-implemented graphics processing system, comprising:
a vertex shader for computing offset texture units based on a supersampled aspect of a thin feature;
a pixel shader for performing additional sampling using the offset texture units; and
a downsampling shader for downsampling a scene to produce a final scene result.

9. The system of claim 8, wherein the aspect is an edge of the thin feature, which edge is 1-pixel wide.

10. The system of claim 9, wherein the pixel shader runs at a higher frequency to capture thin geometry features.

11. The system of claim 8, wherein the offset texture units computed by the vertex shader are utilized as anti-aliasing sampling information.

12. The system of claim 8, further comprising a triangulation component for generating triangle data as the offset texture units based on triangulation along a Bezier curve as applied to the thin feature.

13. The system of claim 8, wherein the vertex shader, pixel shader and downsampling shader operate exclusively on a GPU to provide Bezier path rasterization.

14. A computer-implemented method of processing graphics, comprising:
oversampling an edge of a feature in a scene to obtain geometry information;
computing anti-aliasing sampling information as offset texture units based on the geometry information;
performing additional sampling using the offset texture units;
redrawing the scene based on the additional sampling and geometry information; and
downsampling the redrawn scene to produce final rendered results.

15. The method of claim 12, wherein the offset texture units are offset Bezier texture units obtained from a Bezier object.

16. The method of claim 12, further comprising running a pixel shader at a higher frequency to obtain samples of thin features.

17. The method of claim 12, further comprising running a vertex shader to compute the anti-aliasing sampling information.

18. The method of claim 12, further comprising running a pixel shader to obtain the additional sampling.

19. The method of claim 12, further comprising:
generating triangles for the feature;
dividing the triangles into edge portions and exterior portions; and
supersampling the edge portions into a supersampled buffer.

20. The method of claim 19, further comprising:
redrawing edge triangles on the feature using pixels computed in the supersampled buffer for the edge portions; and
clearing contents of the supersampled buffer for a next frame.
